(19) United States
(12) Patent Application Publication
(10) Pub. No.: US 2026/0238875 A1
(43) Pub. Date: Aug. 13, 2026

(54) DEPTH CAMERA AND UWB BEACON DEPLOYMENT OPTIMIZATION

(71) Applicant: Dell Products L.P., Round Rock, TX (US)

(72) Inventors: Xuebin He, Westwood, MA (US); Yichun Xu, Everett, MA (US); Michael Robillard, Shrewsbury, MA (US)

(21) Appl. No.: 19/052,115

(22) Filed: Feb. 12, 2025

(51) Int. Cl. H04N 23/611; H04N 23/695

(52) U.S. Cl. CPC H04N 23/611; H04N 23/695

(57) ABSTRACT

One example method includes detecting, using a camera, a presence of a user in an operating environment, acquiring, by a beacon, a location of the user in the operating environment, tracking, using the beacon, movement of the user in the operating environment, obtaining, by the beacon, location information indicating a location of the user in the operating environment, and using the location information to control operation of the camera so that the camera follows the user.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to processes, infrastructure, and algorithms that are needed to generate data network effects that may serve to improve the predictions and performance of generative AI (artificial intelligence) systems. More particularly, at least some embodiments relate to systems, hardware, software, computer-readable media, and methods for depth camera and UWB beacon deployment optimization.

### BACKGROUND

Locating and tracking one or more individuals in particular environment may be difficult to do. For example, devices such as beacons and cameras typically have to be calibrated so that they are able to usefully interact with each other. As another example, the location of a user may be determined in only relatively non-specific terms, such as an assessment that a user is, or is not, in a room.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a schema where a user single user is located and tracked, according to one embodiment.

FIG. 2 discloses aspects of a schema where multiple users are located and tracked, according to one embodiment.

FIG. 3 discloses aspects of a method, according to one embodiment.

FIG. 4 discloses aspects of a computing entity configured, and operable, to perform any of the disclosed methods, processes, and operations, according to one embodiment.

### DETAILED DESCRIPTION OF SOME EXAMPLE EMBODIMENTS

Embodiments disclosed herein generally relate to processes, infrastructure, and algorithms that are needed to generate data network effects that may serve to improve the predictions and performance of generative AI (artificial intelligence) systems. More particularly, at least some embodiments relate to systems, hardware, software, computer-readable media, and methods for depth camera and UWB beacon deployment optimization.

One example embodiment may comprise a method that may be performed by a system, according to another embodiment, that comprises a camera, a beacon, and computation system, all of which may be co-located at a reference point, or reference area, within, or outside, an operating environment. One such method may comprise operations including, but not limited to: detecting, using a camera, a presence of a user in an operating environment; acquiring, by a beacon, a location of the user in the operating environment; tracking, using the beacon, movement of the user in the operating environment; obtaining, by the beacon, location information indicating a location of the user in the operating environment; and using the location information to control operation of the camera. In an embodiment, the user may be unaware that he/she is being tracked and followed.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that calibration of a beacon and camera to interoperate with each other may be obviated. An embodiment may be able to quickly detect, and reliably track, movement of one or more users in an operating environment. An embodiment may take advantage of signals transmitted by a user mobile phone to locate and track the user in a particular environment. Various other advantages of one or more example embodiments will be apparent from this disclosure.

### A. Context for one or more embodiments for one embodiment

The following is a discussion of aspects of a context for various embodiments. This discussion is not intended to limit the scope of the claims or this disclosure, or the applicability of the embodiments, in any way.

### A.1 Introduction

The retail industry is undergoing a profound transformation driven by rapidly changing consumer preferences, technological advancements, and increasing competition. To remain relevant and competitive in this dynamic landscape, retail enterprises face the challenge of finding innovative ways to engage customers, reduce transactional friction, enhance their shopping experiences, build their brands, and drive business transformation.

This disclosure encompasses a variety of areas. These include, but are not necessarily limited to: product visualization, virtual try-on, store optimization, consumer privacy, and interactive kiosks. By leveraging these technologies, retailers can cater to the increasing demands of tech-savvy consumers who seek convenient, immersive, and informative shopping encounters. As discussed in detail elsewhere herein, some particular embodiments concern the optimized deployment method for an easy and low-cost camera and beacon system, the enhancement of computational efficiency based on depth camera and beacon system, and improvements to an adjustability of a system that comprises one or more depth cameras and beacon systems.

One or more embodiments may involve what are sometimes referred to as data network effects. For example, processes, infrastructure, and algorithms may be used to generate data network effects. A data network effect refers to the situation where the value of a system increases as more data accumulates within it. Realistic creation of data network effects may be attained by automatically capturing and processing contextualized. Data network effects are commonly leveraged in generative AI systems.

Generative AI requires large datasets that must be kept fresh through back-and-forth customer interactions, such as with a virtual assistant for example. To remain competitive, an AI operator must corral data, analyze it, offer predictions, and then seek feedback, such as from one or more users, to sharpen subsequent suggestions. The value of generative AI systems depends on the data that is automatically collected from users. The generative AI system performance—its ability to accurately predict and suggest — thus hinges on the economic principle referred to as data network effects.

Useful bits of data, such as may be generated and employed in a generative AI system, can be found everywhere. As an example, data may come from interactions with buyers, suppliers, and coworkers. A retailer, for example, could track what consumers looked at, what they placed in their cart, and what they ultimately paid for. These minute, seemingly trivial, details can vastly improve the predictions of a generative AI system. This data need not necessarily be sourced from humans pounding keyboards. Such data may, instead, be sensed and gathered using devices and sensors such as microphones, cameras, and other high-resolution sensors, and processed using “Distributed ML” or “Field AI” on tailored infrastructure.

### A.2 Example aspects of various embodiments

It is expected that immersive technology will become a key enabler of business transformation because it enables humans to interact with business information persisted in datastores, machinery represented as digital twins, and artificial intelligence easily and as equals. This idea may be referred to as the immersive enterprise. This disclosure defines an immersive enterprise as a business that leverages immersive technology to perform business transformation. This idea is aligned with what some in the industry define as spatial computing.

Within spatial or immersive environments, other ability to model and improve business processes is only constrained by the processing capabilities of the underlying infrastructure. Thus, an embodiment can leverage real-world physics, or not. An embodiment may make a simulated environment track real time operations or replay the past. Historical analysis, exploratory planning, and new product introduction all become easier. Having these capabilities available to the average business has never happened before. It has the potential to dramatically improve businesses and to reduce transactional friction.

One example embodiment, discussed elsewhere herein, is focused on the retail vertical. However, it is noted that the concepts disclosed herein are largely transferable or applicable to other verticals.

### B. Detailed discussion of aspects of one or more embodiments

### B.1 Introduction

One or more embodiments are generally concerned with A deployment and method method to build and use a UWB beacon and depth camera system for profile building. In one example embodiment, a “system” comprises UWB beacon (signal emitter and receiver), a stereoscopic camera which can see depth, and a computation device for data processing. One embodiment comprises a method with various elements to make a system more efficient. In an embodiment, a system may included a camera and beacon co-located in the same 2D location to obviate the need for performing calibration of the camera/beacon pair, which in turn reduces the computation device set-up workload. An embodiment may comprise an adjustable base that enables a camera to move and track a person or object, and in this way may reduce the number of cameras needed. An embodiment may also comprise an approach for enabling a camera and beacon to collaborate with each other to improve flexibility and reduce camera computation cost.

There are various other platforms currently in use, including Amazon Just Walk Out, Amazon Smart Grocery Carts, Walmart Smart Check Out, and the Walmart Intelligent Retail Lab. By way of contrast with these platforms however, one or more embodiments may leverage features and aspects such as cellphone-based radio telemetry in combination with photonic camera data. In addition, the unique sensing, edge-based compute, and the use of gesture-controlled display technology, creates differentiation.

### B.2 Discussion

### B.2.1 Overview

One or more embodiments may have various capabilities, although no embodiment is required to have any particular capability, or capabilities. For example, one or more embodiments enable the creation and use of an 'endless aisle' by using stereoscopic cameras, smart shelves, AI models, procedural code, ultra-wide band (UWB) radio beacons, smartphone applications, and computer displays. Some examples capabilities and elements of one or more embodiments include, but are not limited to:
1. [PROCESS, INFRA, ALGO FLOW] A process that avoids the necessity of calibration and x-y axis conversion, leading to reduced set-up and maintenance cost.
2. [PROCESS, INFRA, ALGO FLOW] An algorithm that converts a user location to vector format with regard to the location of the system.
3. [PROCESS, INFRA, ALGO FLOW] Use of depth sensing camera with adjustable base and UWB Beacon for fast user location identification.
4. [PROCESS, INFRA, ALGO FLOW] The methods in which a beacon and camera can work either synchronously or asynchronously.

### B.2.2 Aspects of an example architecture

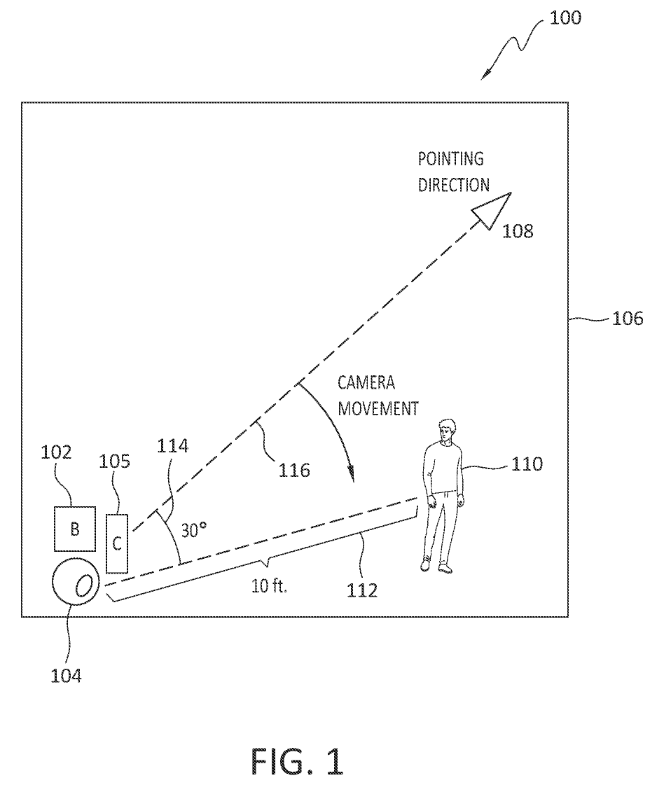

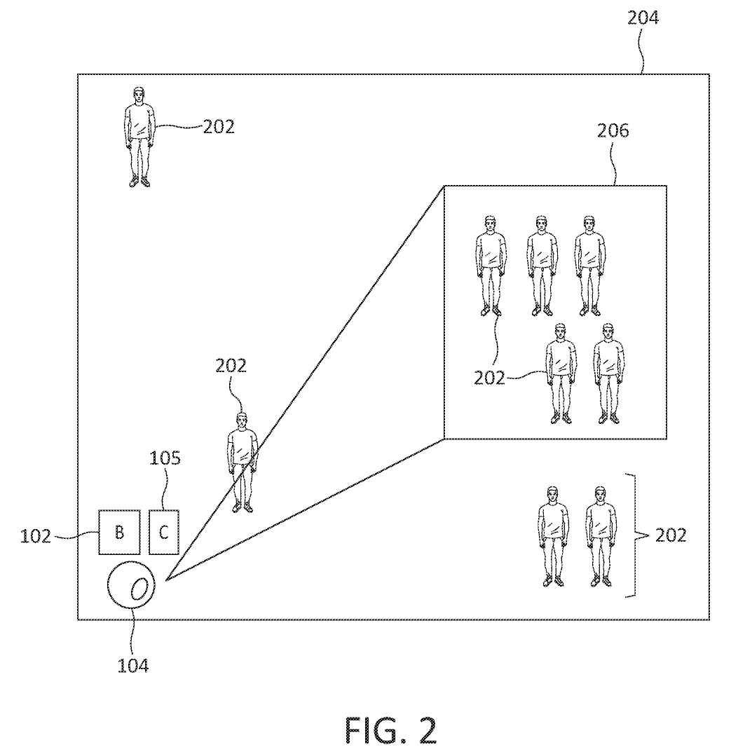

With reference now to FIGS. 1 and 2, aspects of an example architecture, and associated operations, according to one embodiment, are disclosed. In an embodiment, a beacon, such as a UWB beacon, and a camera, such as a stereoscopic camera, may be sourced from the same manufacturer so that they can communicate with each other without any material problems.

As shown in the example schema 100 of FIG. 1, a system comprising a UWB beacon 102 and a depth sensing camera 104, and a computation system 105 which may or may not be integrated into the UWB beacon 102 and/or the depth sensing camera 104, may be co-located in a location within a space 106, such as a room or other physical environment. Both the UWB beacon 102 and the depth sensing camera 104 may be pointed in the same direction 108. In an embodiment, the UWB beacon 102 and the depth sensing camera 104 may be attached to a common mount so that they are able to move in unison with each other. In an embodiment, the depth sensing camera 104 may comprise a rotatable base that enables the depth sensing camera 104 to change to face in different directions. The base may be configured to enable the depth sensing camera 104 to pan from side to side, and also to tilt upwards and downwards.

With the depth sensing camera 104 and the UWB beacon 102 co-located, as shown in the example of FIG. 1, the depth sensing camera 104 and the UWB beacon 102 do not need to be calibrated with respect to the position of the other since they are mounted together and can communicate with each other. There are various approaches for implementing cooperation between the depth sensing camera 104 and the UWB beacon 102. For example, the depth sensing camera 104 and the UWB beacon 102 may remain ‘on,’ that is, ready for immediate operation, constantly. Alternatively, the depth sensing camera 104 may remain ‘OFF’ until a signal from the UWB beacon 102 is detected by the depth sensing camera 104 and, upon detection, the depth sensing camera 104 may change to an ‘ON’ state.

Then, when a user 110 with beacon-enabled smart device, such as a mobile phone for example, enters the space 106 and is detected by the depth sensing camera 104 and/or the UWB beacon 102, the user 110 will be tracked by a receiver of the UWB beacon 102, and by the depth sensing camera 104. The location of the user 110, as determined based on a signal transmitted by a device of the user 110 and received by the UWB beacon 102, may then be provided to the computing system. In an embodiment, the user 110 location may comprise two elements, namely, (1) a distance 112 between the user 102 and the system that comprises the depth sensing camera 104 and/or the UWB beacon 102, and (2) a direction. In an embodiment, the location of the user 110 may be expressed in a vector format (distance , angle ]114]). In the example of FIG. 1, the distance may be expressed by the following vector: [10 ft, 30 degrees (relative to a reference 116)].

The vector may be sent by the UWB beacon 102 and/or the depth sensing camera 104 to the computation system 105, which is operable to control the movement of the depth sensing camera 104. Due to its mounting on an adjustable base, the depth sensing camera 104 will turn, as shown in the example of FIG. 1, to the direction where the signal is received from, that is, toward the user 110.

This approach may be extended to a multiple user scenario. For example, and with reference now to the schema 200 disclosed in FIG. 2, if there are multiple users 202 in a space 204, such as customers in a commercial retail space for example, and each user 202 has a respective device, such as a mobile phone for example, that emits a location signal, the computation system 105 can track all of those signals and, thus, all of the users 202. As shown in the example of FIG. 2, the computation system 105 may calculate the location/perspective 206 with the most users, and accordingly turn the depth sensing camera 104 to that direction.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 300, an example method 300 according to one embodiment is disclosed. In one embodiment, the method 300 may be performed by a beacon/camera pair, which may be part of a system that further comprises a computation system configured to communicate with, and control, the beacon and/or the camera. The example method 300 may be used to track a single user, or multiple users simultaneously. For clarity, the following discussion will refer to a single user, though it is understood the method 300 applies equally well to multiple users. The system may be disposed in any physical area where user detection is desired to be performed. The physical area may, or may not, be partly or completely physically enclosed.

The example method 300 may begin with detection 302 of a user in a physical area by the beacon and/or the camera. Once the person has been detected 302, tracking 304 of the person may be performed. The detection 302 and/or tracking 304 may be performed based on motion detection by a camera and/or receipt by a beacon of a signal emitted by a device, such as a mobile phone, associated with the user.

Next, a beacon may receive a signal from the device associated with the user, and may determine a location 306 of the user based on the signal. The beacon may then transmit, to the computation system, a vector that the computation system may use to control 308 a camera. The vector may include a distance from a reference point, such as where the beacon is located, and an angular displacement of an axis, extending from the reference point to the user, relative to a reference axis passing through the reference point. With this information, the computation system may cause the camera to move along with the user to visually locate the user, and/or to follow the user as the user moves through the physical area.

Information about the user, and movements of the user to different locations in an operating environment may be stored in a log for further reference, action, and analysis. For example, user traffic in a retail environment may be used to help determine product placement and product mix in the retail environment.

### D. Example use cases

Following are some example use cases for one or more embodiments. These are presented by way of illustration and are not intended to limit the scope of this disclosure, or any claims, in any way.

### D.1 Example 1 – Retail store

An embodiment may be employed in a retail environment. For example, an embodiment may be used in a retail store environment, for example, to identify possibly shoplifters, and to enable analyses concerning what areas of a store are of interest to users, and how long the users spend in those areas.

### D.2 Example 2 - Commercial access control

An embodiment may be employed for access control purposes in various commercial environments. For example, an embodiment may, using signals from user devices, determine whether a particular person is authorized or not to enter a secure area. Devices of authorized users may be registered with the system and the system may thus be able to discriminate between authorized and unauthorized users based on signals transmitted by their devices.

### D.3 Example 3 - Amusement park - Line management

Besides retail stores, there are a various other occasions and circumstances in which people must wait in line. An embodiment of a system can be extended to track multiple people and thus determine the number of total people in a particular area or waiting line, so it can be used to track how long each line is. That is, an embodiment may enable a user, for example, to easily decide which line he/she should join in the hospital check-in line. The person can also easily decide whether he/she should join the line for roller coaster first, or the Mickey Mouse show, in Disneyland.

### E. Further Example Embodiments

Following are some further example embodiments. These are presented only by way of example and are not intended to limit the scope of this disclosure or the claims in any way.

Embodiment 1. A method, comprising: detecting, using a camera, a presence of a user in an operating environment; acquiring, by a beacon, a location of the user in the operating environment; tracking, using the beacon, movement of the user in the operating environment; obtaining, by the beacon, location information indicating a location of the user in the operating environment; and using the location information to control operation of the camera.

Embodiment 2. The method as recited in claim 1, wherein the beacon comprises a UWB (ultrawideband) beacon.

Embodiment 3. The method as recited in claim 1, wherein the beacon detects and tracks a cell phone signal of the user.

Embodiment 4. The method as recited in claim 1, wherein controlling operation of the camera comprises moving the camera so that the camera is pointed at the user as the user moves about in the operating environment.

Embodiment 5. The method as recited in claim 1, wherein the camera comprises a stereoscopic depth camera.

Embodiment 6. The method as recited in claim 1, wherein the camera and the beacon are co-located at a common point of reference located within, or outside, the operating environment.

Embodiment 7. The method as recited in claim 1, wherein the location information comprises: (1) a distance from the user to a point of reference where the camera and beacon are located; and (2) an angular displacement of an axis, extending from the reference point to the user, relative to a reference axis passing through the point of reference.

Embodiment 8. The method as recited in claim 1, wherein the beacon simultaneously tracks the user along with one or more additional users.

Embodiment 9. The method as recited in claim 1, wherein control of the camera is effected by a computation system using the location information, and the computation system is configured and operable to communicate with the beacon and with the camera.

Embodiment 10. The method as recited in claim 1, wherein the camera is mounted so as to be capable of tilt, and pan, movements.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

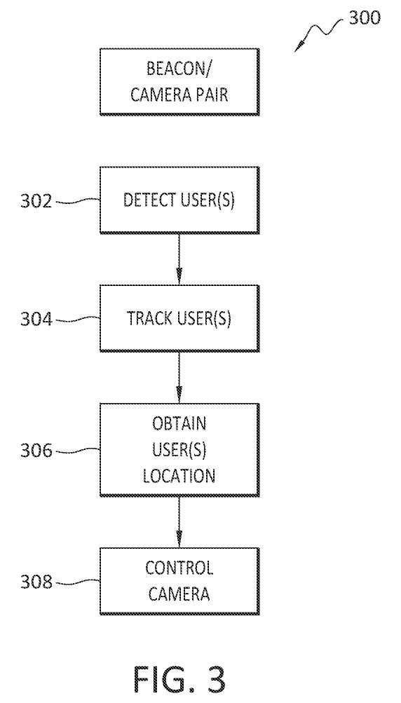

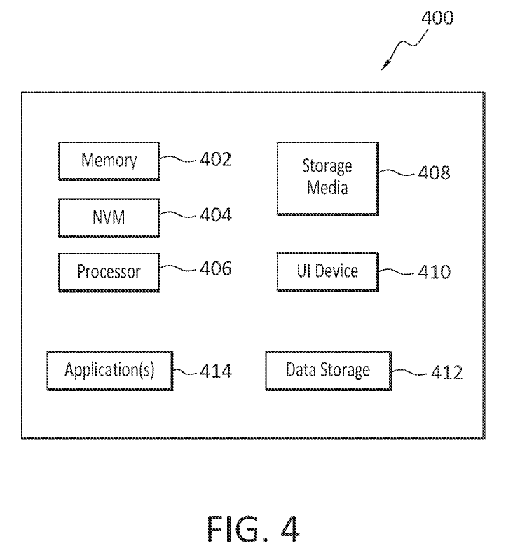

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
detecting, using a camera, a presence of a user in an operating environment;
acquiring, by a beacon, a location of the user in the operating environment;
tracking, using the beacon, movement of the user in the operating environment;
obtaining, by the beacon, location information indicating a location of the user in the operating environment; and
using the location information to control operation of the camera.

2. The method as recited in claim 1, wherein the beacon comprises a UWB (ultrawideband) beacon.

3. The method as recited in claim 1, wherein the beacon detects and tracks a cell phone signal of the user.

4. The method as recited in claim 1, wherein controlling operation of the camera comprises moving the camera so that the camera is pointed at the user as the user moves about in the operating environment.

5. The method as recited in claim 1, wherein the camera comprises a stereoscopic depth camera.

6. The method as recited in claim 1, wherein the camera and the beacon are co-located at a common point of reference located within, or outside, the operating environment.

7. The method as recited in claim 1, wherein the location information comprises: (1) a distance from the user to a point of reference where the camera and beacon are located; and (2) an angular displacement of an axis, extending from the reference point to the user, relative to a reference axis passing through the point of reference.

8. The method as recited in claim 1, wherein the beacon simultaneously tracks the user along with one or more additional users.

9. The method as recited in claim 1, wherein control of the camera is effected by a computation system using the location information, and the computation system is configured and operable to communicate with the beacon and with the camera.

10. The method as recited in claim 1, wherein the camera is mounted so as to be capable of tilt, and pan, movements.

11. A non-transitory storage medium having stored therein instructions that are executable by one or more hardware processors to perform operations comprising:
detecting, using a camera, a presence of a user in an operating environment;
acquiring, by a beacon, a location of the user in the operating environment;
tracking, using the beacon, movement of the user in the operating environment;
obtaining, by the beacon, location information indicating a location of the user in the operating environment; and
using the location information to control operation of the camera.

12. The non-transitory storage medium as recited in claim 11, wherein the beacon comprises a UWB (ultrawideband) beacon.

13. The non-transitory storage medium as recited in claim 11, wherein the beacon detects and tracks a cell phone signal of the user.

14. The non-transitory storage medium as recited in claim 11, wherein controlling operation of the camera comprises moving the camera so that the camera is pointed at the user as the user moves about in the operating environment.

15. The non-transitory storage medium as recited in claim 11, wherein the camera comprises a stereoscopic depth camera.

16. The non-transitory storage medium as recited in claim 11, wherein the camera and the beacon are co-located at a common point of reference located within, or outside, the operating environment.

17. The non-transitory storage medium as recited in claim 11, wherein the location information comprises: (1) a distance from the user to a point of reference where the camera and beacon are located; and (2) an angular displacement of an axis, extending from the reference point to the user, relative to a reference axis passing through the point of reference.

18. The non-transitory storage medium as recited in claim 11, wherein the beacon simultaneously tracks the user along with one or more additional users.

19. The non-transitory storage medium as recited in claim 11, wherein control of the camera is effected by a computation system using the location information, and the computation system is configured and operable to communicate with the beacon and with the camera.

20. The non-transitory storage medium as recited in claim 11, wherein the camera is mounted so as to be capable of tilt, and pan, movements.
